(19) United States
(12) Patent Application Publication
(10) Pub. No.: US 2002/0000146 A1
(43) Pub. Date: Jan. 3, 2002

(54) Bread-cutting machine with crumb deflector

(76) Inventor: Baudouin Van Cauwenberghe, Beersel (BE)

Correspondence Address: LAW OFFICE OF BARRY R LIPSITZ, 755 MAIN STREET, MONROE, CT, 06468, US

(21) Appl. No.: 09/878,835

(22) Filed: Jun. 11, 2001

(30) Foreign Application Priority Data
Jun. 14, 2000 (BE) 2000/0383

(51) Int. Cl. B26D 7/00

(52) U.S. Cl. 83/167; 83/437.2; 83/932

(57) ABSTRACT

A machine for cutting bread into slices, comprising a crumb deflector situated beneath the cutting device in order to receive the crumbs as they fall from the cutting device during the cutting of a loaf and guide them toward a crumb-collecting bin. In an advantageous embodiment, the crumb deflector comprises a front part that slopes down toward the crumb-collecting bin and a rear part that extends to form the rear wall of a compartment. The zone of the machine housing the drive and mechanical transmission members is thus separated from the crumb-receiving zone and is thus kept clean and protected from showers of crumbs.

### BACKGROUND OF THE INVENTION

The present invention relates in a general way to machines for cutting bread into slices and in particular bread-cutting machines equipped with a cutting device comprising reciprocating cutting blades.

A bread-cutting machine of this type generally comprises a frame on which are mounted the housings supporting the cutting blades, the bread-inward and outward tables designed to support the bread before and after cutting, a bread-pushing carriage designed to push the bread toward the cutting blades to be cut and the drive and transmission members for operating the cutting blades and the bread pusher. All these parts are mounted on the machine frame in an arrangement which varies depending on the type of machine.

The drive members are housed inside the machine casing, beneath the loading table and cutting device. During the cutting of a loaf, crumbs are produced and are showered down on the mechanical drive and transmission members of the machine. Some bread-cutting machines are fitted with a drawer for collecting the crumbs at the bottom of the machine, but this does not prevent a shower of crumbs from falling on the mechanical members. It is an object of the invention to avoid this problem.

### SUMMARY OF THE INVENTION

In accordance with the invention, there is provided a bread-cutting machine comprising a crumb deflector situated beneath the cutting device. The crumb deflector slopes down toward a collecting bin so that the crumbs falling from the cutting device while a loaf is being cut slide down toward this bin. The crumb deflector may form the bottom of a compartment that can be closed at the rear. The deflector or the rear wall of the compartment is advantageously extended so as to form a protective screen for the drive and transmission members of the machine, which are thus situated in a protected and always clean area of the machine. Crumbs produced during bread cutting fall onto the bottom of the receiving compartment which guides them on to the collecting bin.

The rear wall of the crumb-receiving compartment can be continued by a wall extending in such a way as to form a practically closed chamber for the drive and transmission members, thereby also helping to soundproof the machine.

The invention is described in greater detail below with the aid of the accompanying drawing.

### BRIEF DESCRIPTION OF THE DRAWING

FIG. 1 shows a diagrammatic cross section through a bread-cutting machine in accordance with the invention. The embodiment illustrated is shown by way of an example, no limitation being implied.

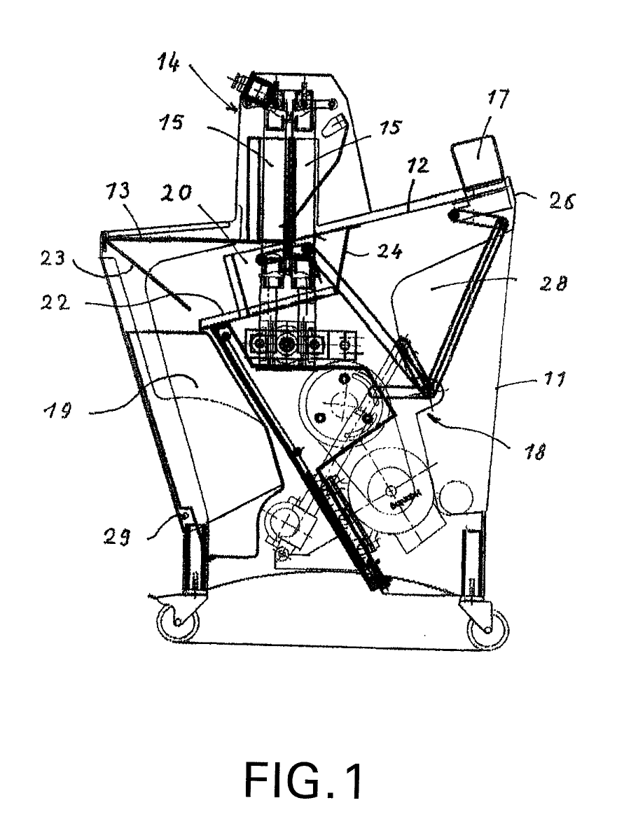

### DESCRIPTION OF AN EMBODIMENT

Across the top of the casing 11 there extend a loading or bread entry table 12 and an unloading or bread exit table 13. Between these two tables stands a cutting device 14 consisting of frames 15 supporting parallel cutting blades. Mounted on the loading table 12 is a bread-pushing carriage 17 capable of sliding along tracks to a cutting device, in a manner known per se. The drive and transmission members for operating the cutting device and moving the bread pusher are housed underneath the loading table 12 and cutting device 14; they are designated as a whole by the reference 18.

Directly underneath the cutting device is a deflector 22 that forms the bottom of a compartment 20 and slopes down toward a crumb-collecting bin 19 positioned inside the machine frame. In this way, crumbs that fall from the cutting device 14 during the cutting of a loaf fall on to the bottom 22 of the receiving compartment 20 and are guided naturally to the collecting bin 19. The latter may for example by located in the front part of the machine with hinge pivots 29 so that the collecting bin can be tilted forward to empty out the collected crumbs.

In the embodiment illustrated, the bottom 22 of the crumb-receiving compartment 20 is produced in the form of a metal sheet and is advantageously extended angularly by a rear wall 24 that closes the compartment 20 and separates it from the rear part 28 of the machine. In this way, the entire lower and rear part of the machine is a permanently crumb-free zone. The drive and transmission members 18 can be housed here and will never be exposed to showers of crumbs. The bottom 22 or the rear wall 24 of the crumb-receiving compartment can even be extended to form a practically closed chamber for the drive and transmission members of the machine.

A fan device can be installed to direct a stream of air at least part of the way along the bottom 22 of the compartment 20. The part of the machine containing the electrical equipment and transmission members is also maintained at slightly above-atmospheric pressure.

A guard panel 23 located at the front of the machine, above the crumb-collecting bin, prevents direct access to the moving parts of the machine for user safety while the machine is running.

It will be understood that the shape of the crumb-receiving compartment is in no way limited to the shape shown in the drawing and that the design of the bread-cutting machine depicted with the provisions of the invention is only an example given without implying any limitation.

1. A machine for cutting bread into slices, comprising a frame with a bread entry table and a bread exit table, a cutting device, a bread pusher device, drive and transmission members for the cutting device and for the bread pusher device, a crumb-collecting device and a crumb deflector situated between said cutting device and said crumb-collecting device.

2. The bread-cutting machine as claimed in claim 1, wherein said crumb deflector is produced in the form of a metal sheet.

3. The bread-cutting machine as claimed in claim 1, wherein said crumb deflector comprises a front part that slopes down toward the crumb-collecting device and a rear part that extends to form the rear wall of a compartment.

4. The bread-cutting machine as claimed in claim 3, wherein said crumb deflector and/or said rear wall form a protective screen for the drive and transmission members.

5. The bread-cutting machine as claimed in claim 3, wherein said crumb deflector and/or said rear wall form a protective screen for the drive and transmission members and wherein said screen is extended to form a practically closed chamber for the drive and transmission members.

6. The bread-cutting machine as claimed in claim 1, wherein said crumb deflector has an angular profile.

7. The bread-cutting machine as claimed in claim 1, wherein said crumb-collecting device is a bin that can be tilted out.

8. The bread-cutting machine as claimed in claim 1, wherein said crumb-collecting device is produced in the form of a drawer that can be extracted from the frame.

9. The bread-cutting machine as claimed in claim 1, wherein said crumb-collecting device is mounted in the front part of the machine and the transmission members are mounted in the rear part of the machine.

10. The bread-cutting machine as claimed in claim 1, comprising a guard panel above the crumb-collecting bin to prevent direct access to the moving parts of the machine.

11. The machine as claimed in claim 1, comprising a fan device installed in such a way as to direct a stream of air flowing at least part of the way along the crumb deflector.
